(19) United States
(12) Patent Application Publication
(10) Pub. No.: US 2009/0201770 A1
(43) Pub. Date: Aug. 13, 2009

(54) TIMEPIECE WITH A CALENDAR NUMBER MECHANISM

(75) Inventor: Frederic Crettex, Prangins (CH)

Correspondence Address: YOUNG & THOMPSON, 209 Madison Street, Suite 500, ALEXANDRIA, VA, 22314, US

(73) Assignee: VAUCHER MANUFACTURE FLEURIER S.A., Fleurier (CH)

(21) Appl. No.: 12/304,132

(22) PCT Filed: May 31, 2007
(86) PCT No.: PCT/EP2007/055287

§ 371 Date: Dec. 10, 2008

(30) Foreign Application Priority Data
Jun. 12, 2006 (EP) 06115263.3

(51) Int. Cl. G04B 19/253

(52) U.S. Cl. 368/35

(57) ABSTRACT

Timepiece with a perpetual calendar number mechanism, including: a time switch, a display device including a mobile (18b) whose position is determined by the calendar month number, a correction device (18a, 18d) cooperating with said display device and guaranteeing its drive at the end of months having less than thirty-one days. This mechanism includes, in addition: a month mechanism (24) with a period of one year and including a cam advancing by steps, one step per month, a programming mechanism (28) driven by the time switch and cooperating with the month mechanism (24) and having a mobile (28a) cooperating with the correction mechanism (18a) to make it advance, during the month, by as many steps as the month counts days in less than thirty-one days. This mechanism enables the energy required to perform the correction to be withdrawn during the month, and restored at the time of the automatic correction.

### TECHNICAL FIELD

The present invention relates to calendar number mechanisms for timepieces. It more particularly concerns calendars of the annual or perpetual type. A perpetual or annual calendar is a mechanism automatically correcting the date when the month has fewer than thirty-one days, depending on whether or not it performs the correct correction for the month of February in leap years.

### BACKGROUND ART

A number of mechanisms of this type are known. For most of them, the jumps of the date indicator are ensured by cams and levers. Such solutions are not very reliable and are greedy in terms of energy.

In document CH 680'630, driving is done without participation by levers or other springs. In this case, however, the timepiece's source of energy is greatly stressed at the end of months having fewer than thirty-one days, and particularly in February, since the display device must perform up to four pitches the same day.

### SUMMARY OF THE INVENTION

The aim of the present invention is to reduce the periodic consumption of energy, by distributing it over the course of the month.

More precisely, the timepiece is provided with a calendar mechanism, comprising:
a dial train,
a display device provided with a wheel and pinion whereof the position depends on the day of the month,
a correction organ cooperating with said display device and ensuring its driving at the end of months having fewer than thirty-one days.

According to the invention, the calendar mechanism comprised by this timepiece also comprises:
a month organ having a period of one year and comprising a cam advancing by pitch, at a rate of one pitch per month,
a programming organ, driven by the dial train and cooperating with the month organ, and provided with a wheel and pinion cooperating with the correction organ to cause it to advance, during the month, by as many pitches as the month has days fewer than thirty-one.

In this mechanism, the correction organ comprises an actuation device connected to the display device to enable it to advance, at the end of the month, by the number of pitches by which the correction organ was advanced during the month which is ending. In this way, this mechanism makes it possible to automatically correct the date during months with fewer than thirty-one days, without, however, necessarily being able to take leap years into account.

Advantageously, the mechanism also comprises a leap year organ cooperating with the programming organ during the months of February, such that, even during leap years, the date is automatically corrected, even in February.

In order to ensure phasing of the correction organ, this comprises a wheel and pinion and an elastic organ connecting this wheel and pinion to the display device.

The programming organ advantageously comprises:
a first wheel kinematically connected to the display device,
a satellite wheel supported by the first wheel,
second and third wheels integral in rotation and engaging with said satellite wheel and the wheel and pinion of the correction organ, respectively, and
at least one holding organ controlled by the programming organ, arranged so as to be able to be engaged or not on the path traveled by the satellite wheel, to thus offset the first and third wheels and, with them, the programming wheel and the display device.

The holding organ is advantageously formed from crowns arranged concentrically to the first, second and third wheels of the programming organ, and jumpers controlled at least by the month organ.

In order to ensure accurate correction of the date even during months of February in leap years, the jumpers are controlled on one hand by the month organ, and on the other hand by the leap year organ.

### BRIEF DESCRIPTION OF THE DRAWINGS

The invention will be better understood upon reading the following description, provided as an example and done in reference to the drawing in which:

FIGS. 1 and 2 illustrate overall perspective and top views, respectively, of a mechanism according to the invention; and

FIGS. 3 and 4 are perspective and top views, respectively, of one part of this mechanism.

### MODES FOR CARRYING OUT THE INVENTION

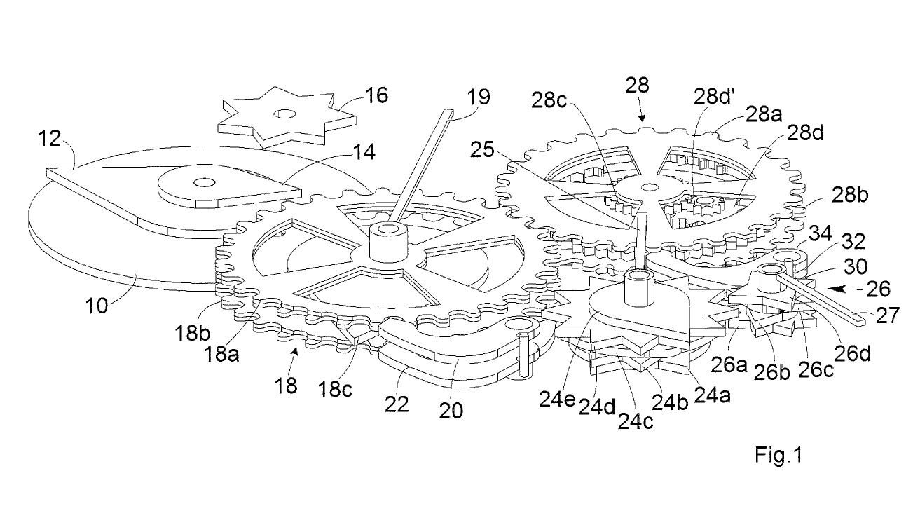

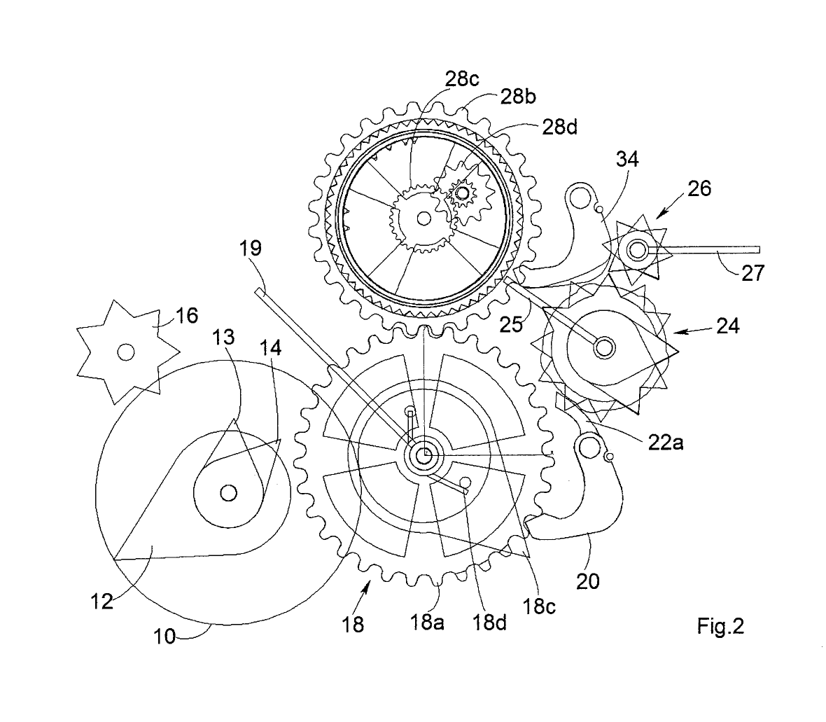

The mechanism illustrated in FIGS. 1 and 2 is controlled by a timepiece dial train which is not shown in the drawing. This train drives a 24-hour wheel 10, which completes one revolution per day. The wheel 10 bears indices 12, 13 and 14, the index 13 being concealed in FIG. 1. A star wheel 16, intended to bear a day of the week indicator, is actuated by the index 12. The indices 13 and 14 are intended to move the perpetual calendar mechanism, as will be explained below. The latter essentially comprises four modules.

A first module 18, of monthly periodicity, comprises two superimposed wheels 18a and 18b, each comprising thirty-one teeth, three of them being truncated in their thickness, as can be seen more particularly in FIG. 1, and driven successively and respectively by the indices 13 and 14. The lower wheel 18b occupies a position corresponding to the day of the month. The display of this function can be done either using a hand 19 supported by its arbor, or by driving a date ring, not illustrated in the drawing.

The upper wheel 18a is rigidly connected with an index 18c the function of which will be specified below. A spring 18d, diagrammatically illustrated in FIG. 2, elastically connects the wheels 18a and 18b to each other. This spring is intended to accumulate energy during the months having fewer than thirty-one days, in order to ensure additional jumps of the wheel 18b at the end of the month, as will be explained below.

The wheels 18a and 18b are respectively positioned by the jumpers 20 and 22, kept bearing in the toothings of these wheels under the effect of springs not shown in the drawing. The jumper 22 is provided with an arm 22a the function of which will be specified below.

A second module 24, of annual periodicity, driven by one pitch each month by the index 18c, comprises, superimposed and rigidly integral with each other:
a star for thirty-day months 24a, comprising four branches arranged such that they are active at the end of the months of April, June, September and November,
a February index 24b comprising two branches,
a cam for months of fewer than thirty-one days 24c, intended to cooperate with the arm 22a of the click 22 to unlock it from the wheel 18b,
a month star 24d with twelve branches, cooperating with the index 18c, and
an index 24e the function of which will be specified below.

This second module 24 is positioned by a jumper spring not illustrated cooperating, traditionally, with the star 24d. It can advantageously bear a hand 25 displaying the month.

A third module 26, of quadrennial periodicity, is controlled by the index 24b. Its function is to manage the jumps associated with the months of February, taking into account whether the year is a leap year, as will be explained below. It comprises, integral in rotation, an eight-branch star 26a intended to cooperate with the two-branch index 24b, a leap year index 26b, a truncated non-leap year star 26c, comprising three branches, two being extensions of each other, the third being perpendicular, as well as a four branch star 26d. The latter part, which pivots freely on the arbor bearing the other components of this module 26, turns under the effect of the index 24e. It is positioned by a jumper not shown in the drawing. A hand 27, indicating the cycle of the leap years, is supported by the star 26d.

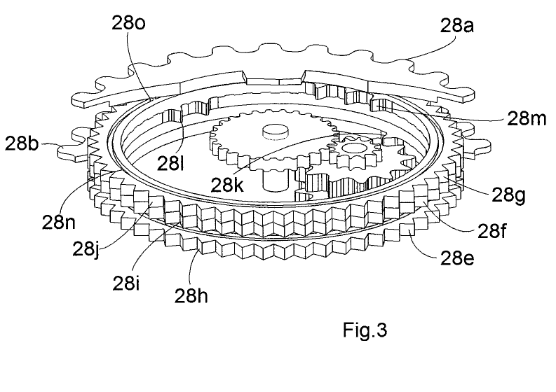

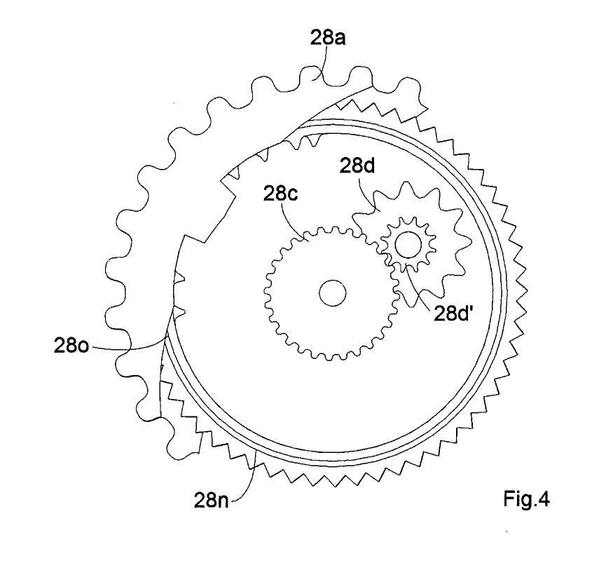

Lastly, a fourth, correction module 28, illustrated in more detail in FIGS. 3 and 4, is made up of a differential comprising:
a first wheel 28a with twenty-eight teeth, engaging with the wheel 18a,
a second wheel 28b, of the same diameter and having the same number of teeth as the wheel 28a, engaging with the wheel 18b,
a third wheel 28c having twenty-eight teeth, interposed between the wheels 28a and 28b, having a smaller diameter and integral with the wheel 28a,
a satellite wheel 28d having twelve teeth, mounted mobile in rotation on the wheel 28b and engaging with the wheel 28c via its pinion 28d′, which also comprises twelve teeth.

One will note that, in FIG. 3, the wheel 28b was truncated, to make it possible to see the part of the module found underneath it.

The wheel 28b also supports, concentrically, mounted mobile in rotation, three crowns 28e, 28f and 28g, provided with an outer toothing 28h, 28i and 28j and with one, two or three inner teeth 28k, 28l and 28m, respectively, intended to cooperate with the satellite wheel 28d. The crowns 28f and 28g are interposed between the wheels 28a and 28b, while the crown 28e is on the other surface of the wheel 28b. Moreover, the satellite wheel 28d has a first plate, the thickness of which is sufficient for it to be found at the level of the two inner toothings 28l and 28m of the crowns 28f and 28g, and a second plate cooperating with the inner toothing of the crown 28e.

As one can see in FIG. 3, the crown 28g is provided with a groove 28n and the wheel 28a with fingers 28c engaged in this groove, ensuring relative positioning of the crown 28g and the wheel 28a. The crowns 28e and 28f are positioned in the same way, in reference to the wheel 28b.

Three jumpers 30, 32 and 34 are arranged so as to be able to be engaged respectively in the toothings 28h, 28i and 28j of the crowns 28e, 28f and 28g and to cooperate with the thirty-day month star 24a, the leap year index 26b and the truncated star 26c.

One will note that the wheels 28a and 28b are arranged such that, during three days per month, their toothing does not engage with the wheels 18a and 18b, respectively, due to the fact that the teeth of the wheels 18a and 18b are truncated in their thickness.

The device as it has just been described is arranged such that, during the months having fewer than thirty-one days, the wheel 18a is dephased in relation to the wheel 18b by one, two or three pitches, in as many days, depending on whether the month in progress has thirty, twenty-nine or twenty-eight days. Its operation is as follows.

Each day, around midnight, the index 12 advances the star wheel 16 of the day of the week indicator by one pitch. This driving is done systematically and independently of the rest of the device. This function may even be removed without changing anything in the operation of the device.

Moreover, the indices 13 and 14 cause the wheels 18a and 18b, respectively, to rotate by one pitch. These drive the wheels 28a and 28b, respectively, except during the three days during which said truncated teeth are found across from the wheels 28a and 28b. The hand 19 jumps one pitch with the wheel 18b to which it is connected. This process takes place every day.

More precisely, the index 13 begins by driving the wheel 18a in the clockwise direction, which causes the wheel 28a to turn and with it, the wheel 28c, in the counterclockwise direction. As the wheel 28b is fixed at that moment, the movement of the wheel 28c causes the pinion 28d′ and the satellite wheel 28d to turn clockwise, by one twelfth of a rotation. Then, the index 14 drives the wheel 18b and, via the latter part, the wheel 28b, which drives the satellite wheel 28d in the counterclockwise direction, which resumes its earlier position on the wheel 28b. When the toothing of the satellite wheel 28d encounters the teeth of one of the inner toothings of the crowns 28e, 28f or 28g, it cooperates with them.

If none of the crowns are held by a jumper, these crowns rotate, without others, with the wheel 28b. In this way, during the months having thirty-one days, the satellite wheel 28d drives, with it, the three crowns 28e, 28f and 28g.

During the months having fewer than thirty-one days, a jumper holds one of the crowns. Thus, during the months of February in non-leap years, the jumper 34 blocks the crown 28g, which comprises three teeth 28m. As the satellite wheel 28d turns clockwise when the wheel 28a advances by one pitch in the counterclockwise direction, its toothing overlaps a tooth of the crown 28g. When, then, the wheel 28b turns by one pitch in the counterclockwise direction, the satellite wheel 28d turns in the clockwise direction while engaging with the toothing of the crown 28g, thus causing the wheel 28a to advance by one additional pitch. The same situation is found the two following days. In this way, the wheel 28a will have moved forward by three additional pitches. Then, the satellite wheel 28d is no longer engaged with the inner toothing of the crown 28g.

For the months having twenty-nine and thirty days, the operation is the same, the satellite wheel 28d cooperating with the crowns 28f and 28e, respectively, which are held by the jumpers 32 and 30, respectively.

In order to enable better understanding of the operation of the device, it will be described according to what happens throughout the entire year.

During the month of December, which is a thirty-one day month, the modules 24 and 26 are in positions such that the jumpers 30, 32 and 34 are not solicited. In this way, all throughout the month, the wheels 18a and 18b turn regularly, driving with them the wheels 28a and 28b and the crowns 28e, 28f and 28g, none of the latter parts being held. Moreover, because of the truncated teeth, the wheels 28a and 28b remain immobile during the three days during the month. Thus, the component parts of the module 28 complete one revolution during the month.

The last day of the month, the index 18c cooperates with the star wheel 24d, such that the components of the module 24 turn by one 30° pitch, bringing the hand 25 into the position corresponding to the month of January. Moreover, the index 24e drives the star wheel 26d and, with it, the hand 27 indicating where the beginning year falls in the cycle of leap years.

The month of January also includes thirty-one days. The wheels 18a and 18b therefore each freely make one complete revolution, driving with them the wheels 28a and 28b and the crowns 28e, 28f and 28g, none of these latter parts being held. Thus, the component pieces of the module 28 once again make one revolution during the month.

When the month changes, the module 24 goes from the position corresponding to January to that corresponding to February, the first branch of the index 24b driving the module 26 by one pitch, with the exception of the star 26d. This module is then positioned such that the jumper 34 is engaged and held in the outer toothing 28j.

As, during the month of January, the three crowns 28e, 28f and 28g have been driven by the satellite wheel 28d, this wheel is ready to engage with the crown 28g, the other crowns 28e and 28f still being driven in rotation. During the first three days, the wheels 18a and 18b are not engaged with the wheels 28a and 28b. On the fourth day, and as the crown 28g is blocked, the satellite wheel 28d engages with one of the inner teeth 28m. As explained above, the satellite wheel 28d turns, driving the wheel 28c and, with it, the wheels 28a and 18a. During three days, the wheel 18a therefore advances, each day, by two pitches, winding the spring 18d.

When twenty-eight days have gone by, the index 18c is found in a position such that it drives the wheel 24d, thereby marking the change of month. The second branch of the index 24b causes the module 26 to rotate by one pitch, with the exception of the star 26d. The jumper 34 is then unlocked. Moreover, the jumper 22 is lifted by the cam 24c, which allows the wheel 18b to align itself on the wheel 18a while making a jump equivalent to four days, thus going from February twenty-eighth to March first. At that time, the truncated toothings of the wheels 18a and 18b are superimposed, and the first tooth finds itself across from the teeth of the wheels 28a and 28b, respectively. As a result, during the first three days of the month of March, the wheels 28a and 28b are immobile.

During the month of March, first the three truncated teeth pass. Then, the satellite wheel 28d bears on the inner teeth 28h, 28i and 28j and causes the crowns 28e, 28f and 28g to turn, until the end of the month. During the passage to the month of April, the module 24 is then driven in rotation by the index 18c, such that it occupies a position in which the crown 28e is blocked by the jumper 30.

As explained above, at the beginning of April, the wheels 18a and 18b again travel three pitches without cooperating with the wheels 28a and 28b, because of the truncated teeth. Then, as the crowns 28e, 28f and 28g were pushed by the satellite wheel 28d bearing against the inner teeth 28k, 28l and 28m, and the crown 28e is blocked by the jumper 30, the satellite wheel 28d engages with the single tooth 28k, which causes the wheel 28a to advance, which drives the wheel 18a one additional pitch. In this way, the index 18c, integral with the wheel 18a, cooperates with the module 24 on the thirtieth of the month, causing it to jump a pitch. Simultaneously, the jumper 22 is lifted, the wheel 18b aligning itself on the wheel 18a, the hand 19 and going directly from the thirtieth to the first.

The module 24 then occupies a position corresponding to the month of May. In this position, none of the jumpers 30, 32 and 34 are solicited. The satellite wheel 28d thus drives the crowns 28e, 28f and 28g in rotation. Arriving at the thirty-first, the index 18c causes the module 24 to jump one pitch, such that it occupies a position corresponding to the month of June. One then finds a situation corresponding to that encountered in April. In other words, the jumper 30 blocks the crown 28e, causing an additional jump of one pitch of the wheels 28a and 18a. The index 18c then causes the module 24 to jump on the thirtieth of the month, causing it to go from June to July.

The month of July takes place like the month of May with, on the thirty-first, a jump of the module 24, which goes to the month of August. During this following month, no jumper is solicited. The satellite wheel 28d therefore continues to cause the three crowns 28e, 28f and 28g to turn. On the thirty-first, the index 18c causes the module 24 to jump by one pitch, such that it is found in the position corresponding to the month of September. In this month again, it is the jumper 30 which blocks the crown 28e. This is why, after the wheels 18a and 18b have gone three pitches without engaging, they then drive the wheels 28a and 28b, respectively, causing an additional jump of the wheel 18a, as was explained in relation to the situation for the month of April.

In October, the operation is the same as in July, and in November the same as in April.

The situation is different in February of leap years, the jumper 32 then blocking the crown 28f, which comprises only two teeth. This therefore means that the wheel 18b will be driven two additional pitches and not three during leap years.

One will note that the mechanism as it has been described has a diagrammatic nature. It is obvious for one skilled in the art to develop it so as to adapt it to the other characteristics presented by the movement to which it is integrated. A number of other variations may also be considered.

For example, dephasing of the wheel 18a during the month could be done in more days. Thus, by providing the crowns 28e, 28f and 28g with two, four and six teeth, respectively, and the wheels 18a and 28a with sixty-two and fifty-six teeth, respectively, winding of the spring 18d would be done in two, four and six days, respectively.

The crown 28g, which comprises three teeth, could be removed, enabling blocking of the two crowns 28e and 28f, while also ensuring dephasing of the latter parts during engagement of their respective jumpers.

The wheels 28a and 28b could also comprise a more limited number of teeth. The module 18 need only be driven in rotation during the number of days necessary to ensure correction of the month of February in a leap year. In the example described in detail, the driving may be done in three days. The wheels 28a and 28b could then be replaced by wheel and pinions driven at a rate of four pitches per month, the wheels 18a and 18b being provided with driving fingers to perform this function.

The mechanism as just described takes leap years into account. The same principle can be applied to a simplified mechanism, called annual. In this case, the module 26 is removed. The jumper 34 would then be controlled by a February cam connected to the module 24. A correction system could be connected, making it possible to control a retreat of one pitch of the wheel 18a during the month, and thereby ensuring the adjustment of the date in February of leap years.

In the mechanism as described, the satellite wheel 28d cooperates with crowns mounted concentrically to the wheels 28a and 28b. This function could also be performed by jumpers controlled by the modules 24 and/or 26, whether or not brought into the path of the jumper wheel 28d and causing it to turn by as many pitches as necessary to dephase the wheels 28a and 28b and, with them, the wheels 18a and 18b.

Thus, thanks to the characteristics presented by the timepiece according to the invention, automatic correction of the date is done at a rate of at most one additional pitch per month, which makes it possible to regulate energy withdrawal.

1-6. (canceled)

7. A timepiece provided with a calendar mechanism, comprising:
a dial train,
a display device provided with a wheel and pinion whereof the position depends on the day of the month,
a correction organ cooperating with said display device and ensuring its driving at the end of months having fewer than thirty-one days,
wherein said mechanism also comprises
a month organ having a period of one year and comprising a cam advancing by pitch, at a rate of one pitch per month,
a programming organ, driven by the dial train and cooperating with the month organ, and provided with a wheel and pinion cooperating with the correction organ to cause it to advance, during the month, by as many pitches as the month has days fewer than thirty-one, and
wherein said correction organ comprises an actuation device connected to the display device to enable it to advance, at the end of the month, by the number of pitches by which the correction organ was advanced during the ending month.

8. The timepiece according to claim 7, wherein said mechanism also comprises a leap year organ cooperating with said programming organ during the months of February.

9. The timepiece according to claim 7, wherein said correction organ comprises a wheel and pinion and an elastic organ connecting said wheel and pinion to the display device.

10. The timepiece according to claim 9, wherein said programming organ comprises:
a first wheel kinematically connected to the display device,
a satellite wheel supported by the first wheel,
second and third wheels integral in rotation and engaging with said satellite wheel and the wheel and pinion of the correction organ, respectively, and
at least one holding organ controlled by said programming organ, arranged to be able to be engaged or not on the path traveled by said satellite wheel, to offset the first and third wheels and, with them, said programming wheel and the display device.

11. The timepiece according to claim 10, wherein said holding organ is formed of crowns arranged concentrically to said first, second and third wheels of the programming organ, and jumpers controlled at least by the month organ.

12. The timepiece according to claim 8, wherein said correction organ comprises a wheel and pinion and an elastic organ connecting said wheel and pinion to the display device.

13. The timepiece according to claim 12, wherein said programming organ comprises:
a first wheel kinematically connected to the display device,
a satellite wheel supported by the first wheel,
second and third wheels integral in rotation and engaging with said satellite wheel and the wheel and pinion of the correction organ, respectively, and
at least one holding organ controlled by said programming organ, arranged to be able to be engaged or not on the path traveled by said satellite wheel, to offset the first and third wheels and, with them, said programming wheel and the display device.

14. The timepiece according to claim 13, wherein said holding organ is formed of crowns arranged concentrically to said first, second and third wheels of the programming organ, and jumpers controlled at least by the month organ.

15. The timepiece according to claim 14, wherein said jumpers are controlled on one hand by the month organ, on the other by the leap year organ.
